(19) United States
(12) Patent Application Publication
(10) Pub. No.: US 2003/0234721 A1
(43) Pub. Date: Dec. 25, 2003

(54) Forklift electronic vertical leveler

(76) Inventor: Randall S. Figueira, Vacaville, CA (US)

Correspondence Address: WILLIAM S. BERNHEIM, 255 N. Lincoln Street, Dixon, CA, 95620, US

(21) Appl. No.: 10/174,713

(22) Filed: Jun. 20, 2002

(51) Int. Cl. B66F 17/00

(52) U.S. Cl. 340/440; 701/50

(57) ABSTRACT

An apparatus is provided for warning when the mast of a forklift is not in perfect vertical and (i) the direction, e.g. forward or backward the mast is tilted, and (ii) the relative degree of offset from perfect vertical. The apparatus includes an operations package including a power supply, a control unit, an alarm unit and a level state detector for detecting the state of the forklift's mast thus permitting dramatically more economical and safer forklift operation.

### BACKGROUND OF THE INVENTION

1. Field of the Invention

This invention relates generally to forklifts and like devices and especially for systems and methods for more efficacious deployment of forklifts and like devices.

2. Description of the Prior Art

Forklifts (herein defined as including reach-trucks, sit down counter balances, and like devices) are essential in modem trade and commerce. Forklifts have a wide variety of height capabilities depending upon use requirements. In all cases, it is essential that a forklift's mast be in “perfect vertical”, meaning that the long axis of the mast defines a ninety degree angle with the plane of the earth, for maximum load carrying capacity, safety, and avoidance of damage to cartons and packages.

However, it is extremely difficulty for a forklift operator to know whether or not the mast of the forklift being operated is in perfect vertical. The rather high masts of industrial forklifts make ascertaining whether or not a mast is in perfect vertical an extremely difficult and essentially impossible task. Therefore, much time is spent by the forklift operator trying to ascertain whether or not the mast of the forklift being operated is in the perfect vertical, including experimentally attempting to slide the carrying forks into the slats beneath pallets. Every time a mistake is made, considerable damage to valuable goods is likely to be incurred, as the forks, if not in perfect vertical, miss their intended target and puncture packaging, damaging goods. Consequently, forklift operators must be careful, and thus spend much non productive time experimentally ascertaining whether or not the carrying forks of the forklift under operation are safely entering the slats of the pallet. Resultantly, much time is lost.

Furthermore, due to the fact that considerable carrying capacity is lost for every degree offset from perfect vertical, forklift operators must necessarily use much less than the intended loading capacity of the forklift with the mast at perfect vertical for safety reasons. Resultantly again, much time, and productivity is lost.

The inability of forklift operators to know with certainty that the mast of the forklift is in perfect vertical without needing to guess or empirically verify the mast's position results in dramatic losses in productivity due to repeated attempts to place the carrying forks in slats, and the reduced carrying load per voyage. Considerable insurance expenses are also incurred due to the rather high propensity for damaging goods. Consequently, it can be readily appreciated that a forklift which has the ability to readily and reliably be placed in a verified perfect vertical satisfies a long felt need in the industry.

As such, the general purpose of the present invention is to provide a forklift including a mast leveling aid and system which has all the advantages associated with current forklifts and has none of the disadvantages.

To attain this, the invention provides an electronic vertical mast leveler apparatus both for warning when the forklift mast is not in perfect vertical as well as indicating how far offset from perfect vertical is the mast, and for notifying when it is in perfect vertical. In a preferred embodiment of the present invention the level state detection mechanism and the indicator are configured and cooperatively coupled so as to be able to provide differentiated signals indicating the degree to which the forklift mast is offset from perfect vertical to aid the forklift operator in expeditiously making any necessary adjustments to the angle of the mast.

### OBJECTS OF THE INVENTION

It is an object of the present invention to provide an effective method and system for the indication and notification of the level and perfect vertical or unleveled and non-perfect vertical state of a forklift's mast to the operator.

It is further an object of the present invention to provide an alarm and/or alert permitting ready detection by the forklift operator of the degree offset from perfect vertical that the forklift mast may be in.

These and other objects and advantages will be apparent to those skilled in the art in light of the following disclosure, claims and accompanying drawings.

### BRIEF DESCRIPTION OF THE DRAWINGS

FIG. 1 is a block diagram illustrating the connection of various components of an operations package to a control unit of the forklift electronic vertical leveler of the present invention.

### DESCRIPTION OF THE PREFERRED EMBODIMENTS

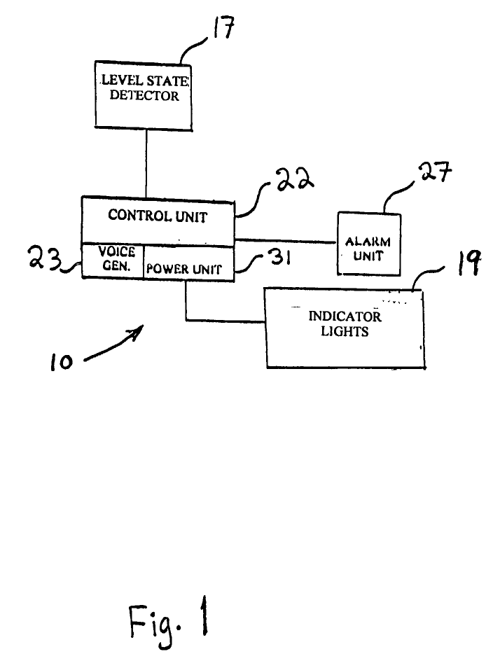

FIG. 1 illustrates components of an operations package 10 disposed about a forklift (not shown) in accordance with the present invention. Although not specifically illustrated, the forklift has a mast, lifting forks, operator's seat and at least one hydraulic piston or other suitable actuators adapted to selectively move the orientation of the mast relative to the frame of the forklift at the discretion of the operator. The forklift electronic vertical leveler's operations package 10 includes a level state detector 17 mounted on and incorporated about the forklift's mast. The level state detector 17 may be any suitable leveling device, including a gravity pendulum, fluid and bubble type level indicator especially including a conductive fluid, or other gravity dependent level state indicator. Further, the level state indicator 17 may not necessarily be gravity dependent, but rather may read the relative orientation of the mast to the position of an unmovable remote sensor unit fixedly mounted elsewhere on, say, the frame of the forklift. In a simplest embodiment, the level state detector includes a simple gravity pendulum and dial capable of indicating the orientation of the long dimension of the mast relative to the plane of the earth's surface, including any degrees offset from perfect vertical.

The level state detector may include a gravity actuated pendulum cooperatively coupled to the remainder of the operations package 10 making up the electronic vertical leveler of the present invention (see FIG. 1). Such gravity actuated pendulum may be configured and designed to selectively conduct from the power unit to the control unit different current, and different amounts of current, depending upon the pendulum's position. E.g. if the gravity actuated pendulum is titled due to the long dimension of the mast being offset forward of the forklift from perfect vertical it provides, say, a positive current. Similarly, if the gravity actuated pendulum is tilted due to the long dimension of the mast being offset backward from perfect vertical and toward the remainder of the forklift it provides, say, a negative current. The degree of offset, either backward or forward, may further result in correspondingly increased or decreased contact between position dependent conductive contacts disposed upon the gravity actuated pendulum so as to increase or decrease the current depending on, relatively, the degree offset away from or close to perfect vertical, excepting perfect vertical itself. In the perfect vertical position, i.e. when the forklift's mast's long axis defines a ninety degree angle to the plane of the earth's surface, the gravity actuated pendulum preferentially fails to provide a conductive path for any current between the power supply and the control unit.

As seen in FIG. 1, the operations package 10 of the electronic vertical leveler of the present invention further includes control unit 22 and a power source such as a battery (including the forklift's battery), as indicated by power unit 31, cooperatively coupled with level state detector 17 in such a fashion and configuration as to permit the detection of the “FORWARD” or “BACKWARD” tilted state of forklift's mast. Operations package 10 further includes an alarm generators 23 and 27 coupled to control unit 22.

Upon the supply of power to electronic vertical leveler of the present invention, such as by ignition of the forklift's motor, a forward or backward tilt of the mast by the level state detector 17 stimulates level state detector 17 to generate and send to control unit 22 either a “FORWARD” or a “BACKWARD” signal as appropriate and indicative of the degree offset from perfect vertical of mast. For example, the farther offset from perfect vertical, the stronger or weaker may be the current. Upon receiving the “FORWARD” or “BACKWARD” signal control unit 22 is designed and configured to preferably generate an alarm to remind the forklift driver that the mast is offset, and in which direction. For example, the alarm unit 27 controlled by control unit 22 generates an audible voice instructing the driver that the mast is either tilted “FORWARD” or “BACKWARD”, as appropriate. Simultaneously, the control unit preferably activates its indicator lights unit 19 to energize lights visible to the forklift driver with a distinct flashing.

The control unit is designed and configured to direct current to lights located on the forklift in a convenient viewing position for the driver. The lights differentiate to the driver the either “FORWARD” or “BACKWARD” tilt of mast, including the degree offset, aiding the drive in making necessary corrections to the position of mast. For example, the farther offset is mast, the more quantity of lights may be activated by the control unit, which may be blinking lights, including more or less rapidly blinking lights indicative of more or less offset to the orientation of the mast, respectively. Thus, greater opportunity for safety is provided.

In the absence of any offset to the mast, that is in perfect vertical, the control unit fails to receive any power and concurrently fails to generate any alarm. Thus, the operator realizes that the mast is in perfect vertical.

Control unit 22 can be implemented utilizing programmed general purpose processors, application specific processors, firmware and discrete components or combinations thereof.

Due to the easy implementation of portability of control unit 22 and in general operations package 10, the forklift electronic vertical leveler apparatus and system of the present invention may be deployed into any forklift without requiring an integrated on board control unit. The result is enhanced safety, efficiency and profitability of forklift operations.

Resultantly, the foregoing objects of the present invention have been attained.

Although the present invention has been shown and described with respect to preferred embodiments thereof, it should be understood by those skilled in the art that various changes and omissions in the form and detail thereof may be made therein without departing from the spirit and scope of the invention as defined in the appended claims.

I claim:

1. A forklift having a vertically oriented mast and an apparatus and mechanism for the detection and alert of the position of a mast of the forklift comprising a level state detector cooperatively coupled to the vertically oriented mast.

2. A forklift including an apparatus and mechanism for the detection and alert of the position of a mast of the forklift comprising:
(a) a level state detector for detecting the state of the forklift and capable of being activated when the position of the mast is offset from perfect;
(b) a control unit for generating an alarm signal when the level state detector activates and provides a signal to the control unit; and
(d) a power unit for supplying electrical power to the control unit.

3. The apparatus of claim 2 wherein the level state detector includes a gravity actuated pendulum.

4. The apparatus of claim 2 wherein the alarm signal includes an indicator light.

5. The apparatus of claim 2 wherein the power supply is a main battery of the forklift.

6. The apparatus of claim 2 wherein an audible alarm is generated upon activation of the alarm unit.

7. The apparatus of claim 2 wherein the level state detector is capable of detecting and generating a discriminatory signal dependent upon the amount offset from perfect vertical of the mast.

8. The apparatus of claim 2 wherein the level state detector is capable of detecting and generating a discriminatory signal dependent upon the direction backward or forward the mast is offset from perfect vertical.
